(19) United States
(12) Patent Application Publication
(10) Pub. No.: US 2012/0247779 A1
(43) Pub. Date: Oct. 4, 2012

(54) INHIBITING LIQUID LOADING, CORROSION AND/OR SCALING IN OILFIELD TUBULARS

(76) Inventor: Cornelis Adrianus Maria Veeken, Assen (NL)

(21) Appl. No.: 13/515,302

(22) PCT Filed: Dec. 14, 2010
(86) PCT No.: PCT/EP2010/069658

§ 371 Date: Jun. 12, 2012

(30) Foreign Application Priority Data
Dec. 14, 2009 (EP) 09179115.2

(51) Int. Cl. E21B 43/12; B05D 7/22; E21B 17/00

(52) U.S. Cl. 166/310; 166/242.4; 427/230

(57) ABSTRACT

Liquid loading, corrosion and scaling in an oilfield tubular, such as a production tubing in a natural gas production well, is inhibited by treating the inner surface of the oilfield tubular (4,24) with a hydrophobic or other coating or lining which inhibits creation of a liquid film and promotes liquid droplet flow alongside said inner surface.

### BACKGROUND OF THE INVENTION

The invention relates to a method for inhibiting liquid loading, corrosion and scaling in oilfield tubulars, in particular in production tubings in natural gas production wells.

Condensation of liquids in natural gas production wells may inhibit production of natural gas through such wells when the gas velocity becomes insufficient to carry these liquids to surface, a phenomenon also known as liquid loading. Condensation of liquids is triggered in almost all gas wells by expansion of the gas within the well and by the lowering of the temperature of the earth crust along the length of the wellbore from the inflow region to the wellhead. In addition, free liquid may be entering the inflow region together with the gas.

Besides triggering liquid loading, the condensed and free liquid also interacts with the tubing inner surface where, depending on the composition of liquid and tubing, it can cause unacceptable corrosion and scaling.

It is known to inhibit liquid loading of gas wells from SPE papers 71554 and 84136.

SPE paper 71554 “Design of tubing collar inserts for producing gas wells below their critical velocity” was presented by S. A. Pura et al at the 2001 SPE Annual Technical Conference and Exhibition held at New Orleans, La., USA from 30 Sep. to 3 Oct. 2001.

SPE paper 85136 “Investigation of new tool to unload liquids from stripper-gas wells” was presented by A. J. Ali et al at the SPE Annual Technical Conference and Exhibition held in Denver, Colo., USA from 5 to 8 Oct. 2003.

SPE paper 71554 discloses that the use of open or slotted disks inserted at selected points along the length of production tubing inhibits liquid loading.

SPE paper 84136 discloses the use of a vortex device, which alters the flow structure in the production tubing and improves liquid flow.

A disadvantage of the methods known from these SPE papers is that the vortex device and open or slotted disk provide flow restrictions, which reduce the production of gas and only provide local reduction of liquid loading in the vicinity of the vortex device or open or slotted disk.

The article “Experimental Study of gas-liquid two phase-flow affected by wall surface wettability” published by T. Takamasa et al in the International Journal of Heat and Fluid Flow 29 (2008) 1593-1602, Journal Homepage: www.elsevier.com/locate/ijff, describes experiments to evaluate the effect of wall surface wettability on the characteristics of upward gas-liquid two phase flow in vertical pipes. The experiments are of an academic nature and no practical implications are disclosed in this article.

There is a need to alleviate the disadvantages of the methods known from the above SPE papers and to provide a method for inhibiting liquid loading in oilfield tubular, such as production tubings in gas wells, wherein liquid loading may be inhibited along at least a substantial part of the length of a gas well and wherein there is no need to inhibit the flux of natural gas by vortex tools, open or slotted disk inserts or other flow obstructing devices.

There is also a need to inhibit contact between the tubing wall and the condensed or free liquid and to thereby inhibit corrosion and scaling of the inner surface of gas well production tubings and other oilfield tubulars.

### SUMMARY OF THE INVENTION

In accordance with the invention there is provided a method for inhibiting liquid loading, corrosion and/or scaling in an oilfield tubular by treating the inner surface of the tubular with a hydrophobic coating or lining to inhibit the formation of a liquid film contacting the surface, thereby promoting the transport of liquid as droplets flowing in an upward direction alongside said inner surface while minimizing contact between the liquid and the inner surface.

The treatment preferably comprises coating at least part of the inner surface of the oilfield tubular with a compound having a low surface energy and a low contact angle hysteresis, such as a hydrophobic coating or lining.

In accordance with the invention there is furthermore provided an oilfield tubular, of which the inner surface is treated to inhibit the creation of a liquid film and to promote the transport of liquid as droplets while minimizing contact with said inner surface.

The oilfield tubular may be a production tubing for use in a gas well of which the inner surface is provided a ceramic or fluor based hydrophobic coating, such as a fluoridated hydrocarbon coating comprising polymerized acrylic compounds.

These and other features, embodiments and advantages of the method and oilfield tubular according to the invention are described in the accompanying claims, abstract and the following detailed description of non-limiting embodiments depicted in the accompanying drawings, in which description reference numerals are used which refer to corresponding reference numerals that are depicted in the drawings.

### BRIEF DESCRIPTION OF THE DRAWINGS

FIG. 1 shows a schematic of the concurrent flow of gas and liquid in a section of a gas well where the gas flow is sufficient to move both liquid film and liquid droplets upward; and

FIG. 2 shows a schematic of the concurrent flow of gas and liquid in a section of a gas well where the gas flow is insufficient to move the liquid film upward but still sufficient to move the liquid droplets upward

### DETAILED DESCRIPTION OF THE DEPICTED EMBODIMENTS

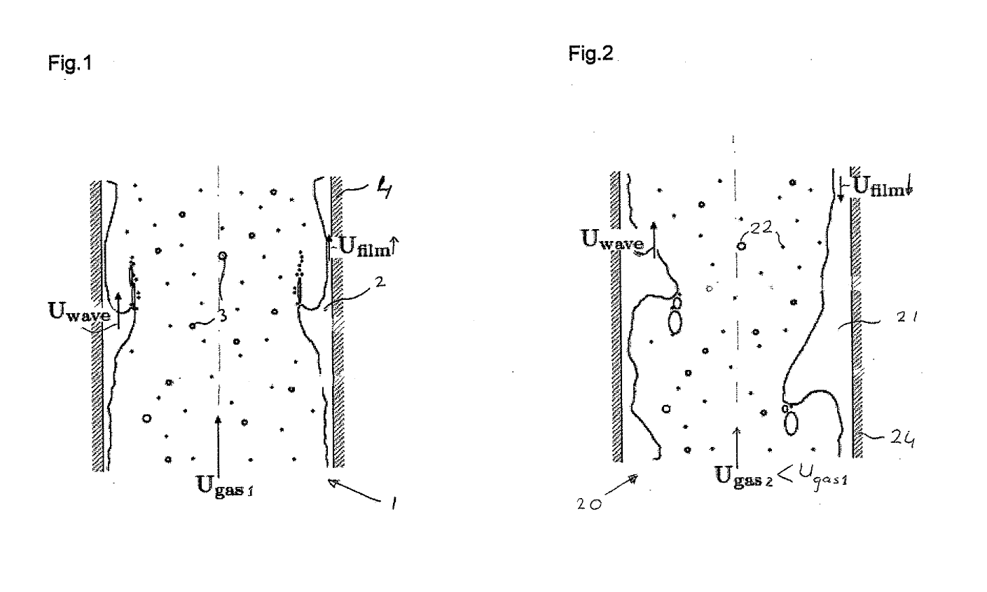

FIG. 1 shows a gas well 1 with liquid film 2 alongside the inner surface of the production tubing 4 and liquid droplets 3 that are dragged upward through the interior of the production tubing 4 by the upward velocity U_{gas1} of natural gas. In the situation shown in FIG. 1 the upward gas velocity U_{gas1} is sufficient to also drag the liquid film 2 in an upward direction alongside the inner surface of the production tubing 4 as illustrated by the arrow U_{film↑}. Drag forces exerted by the upward gas flux will also initiate waves at the inner surface of the liquid film 2 that move in an upward direction as illustrated by arrow U_{wave↑} and with wave crests that tilt in an upward direction.

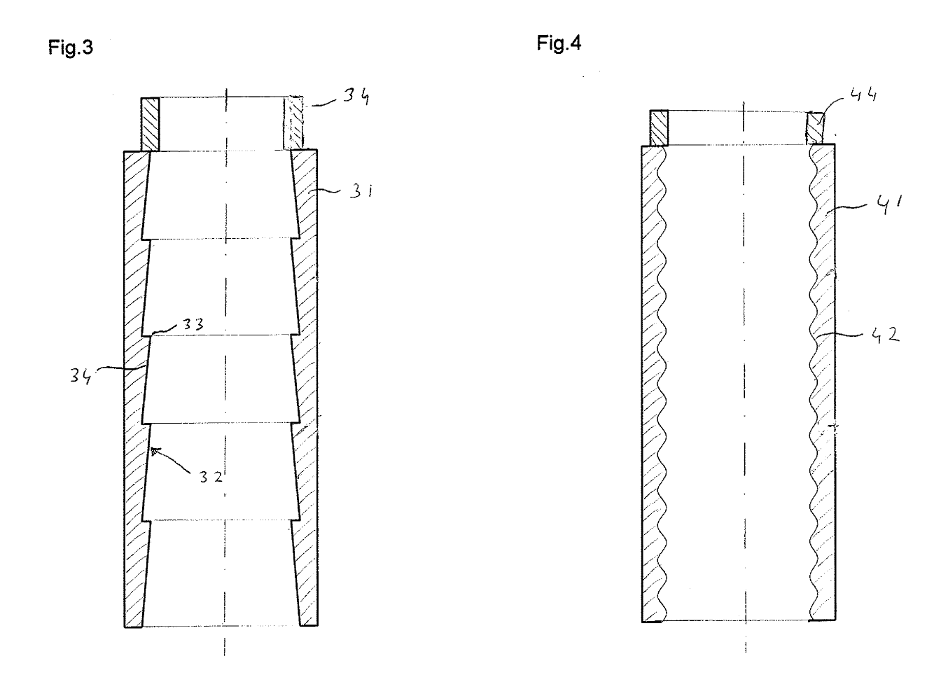

FIG. 2 shows a gas well 20 with liquid film 21 and liquid droplets 22, wherein the upward gas velocity U_{gas2} is lower than the U_{gas1} shown in FIG. 1.

The reduced gas velocity U_{gas2} is still sufficient to drag liquid droplets upwards but insufficient to move the liquid film 21 in an upward direction along the inner surface of the production tubing 24.

The drag forces exerted by the upward gas flux initiate waves at the inner surface of the liquid film 21, which still move upward, but at a lower speed than shown in FIG. 1 and with wave crests that tilt in downstream direction. The downward velocity of the liquids in the liquid film U_{film↓} may result in liquid accumulation at the bottom of the the production tubing 24, which may inhibit and eventually terminate the influx of gas into the well 20.

Experiments have shown that applying hydrophobic coating to the inner surface of the production tubing will inhibit creation of the liquid film and will reduce the gas velocity at which liquid loading occurs by about 50%. This observation matches the upward gas velocity required to transport liquid droplets in upward direction. Liquid loading in gas wells will result in liquid accumulation at the bottom of the well, which will inhibit gas production from this well.

Inhibiting the creation of a liquid film will also inhibit corrosion and scaling at the tubing inner wall. Corrosion and scaling trigger costly preventative or corrective maintenance to either prevent or repair the detrimental effects of corrosion and scaling. Therefore, hydrophobic coating of production tubing will extend the life a wet gas production well.

Suitable hydrophobic coating materials are ceramic or fluor based coatings, such as a fluoridated hydrocarbon coating comprising polymerized acrylic compounds.

The hydrophobic coatings according to the invention may also be used to inhibit liquid loading, corrosion and/or scaling in other oilfield tubulars than production tubings in gas wells, such as in surface flowlines and/or risers for transporting natural gas, condensate and/or a multiphase mixture of crude oil, condensate and natural gas from multiphase hydrocarbon fluid production wells to hydrocarbon processing facilities.

1. A method for inhibiting liquid loading, corrosion and/or scaling in an oilfield tubular, the method comprising treating at least part of an inner surface of the tubular to inhibit the creation of a liquid film and to promote the transport of liquid as droplets while minimizing contact with said inner surface.

2. The method of claim 1, wherein the treatment comprises coating at least part of the inner surface with a compound having a low surface energy and a low contact angle hysteresis.

3. The method of claim 1, wherein the treatment comprises providing at least part of the inner surface of the oilfield tubular with a hydrophobic coating or lining.

4. The method of claim 3, wherein the hydrophobic coating is a ceramic or fluor based hydrophobic coating.

5. The method of claim 4, wherein the hydrophobic coating is a fluoridated hydrocarbon coating comprising polymerized acrylic compounds.

6. The method of claim 1 wherein the oilfield tubular is a production tubing in a natural gas production well.

7. The method of claim 6, wherein the natural gas production well is a wet and/or sour natural gas production well.

8. An oilfield tubular of which the inner surface is treated to inhibit corrosion, scaling and the creation of a liquid film and to promote the transport of liquid as droplets while minimizing contact with said inner surface.

9. The oilfield tubular of claim 8, wherein the treatment comprises a coating that covers at least part of the inner surface, which coating comprises a compound having a low surface energy and a low contact angle hysteresis.

10. The oilfield tubular of claim 8 wherein the inner surface is provided with a hydrophobic coating or lining.

11. The oilfield tubular of claim 10, wherein the hydrophobic coating is a ceramic or fluor based hydrophobic coating.

12. The oilfield tubular of claim 11, wherein the hydrophobic coating is a fluoridated hydrocarbon coating comprising polymerized acrylic compounds.

13. The oilfield tubular of claim 1 wherein the oilfield tubular is a production tubing for use in a crude oil and/or natural gas production well.

14. The oilfield tubular of claim 13, wherein the oilfield tubular is a production tubing for use in a wet and/or sour natural gas production well.

15. The oilfield tubular of claim 8, wherein the oilfield tubular is a surface flowline or riser for transporting natural gas, condensate and/or a multiphase mixture of crude oil, condensate and natural gas from a multiphase hydrocarbon fluid production well to hydrocarbon processing facilities.
